(19) United States
(12) Patent Application Publication
(10) Pub. No.: US 2015/0005972 A1
(43) Pub. Date: Jan. 1, 2015

(54) ELECTRIC POWER SYSTEM TREE DISPLAY SYSTEM AND ELECTRIC POWER SYSTEM TREE DISPLAY METHOD

(71) Applicant: NEC CORPORATION, Minato-ku, Tokyo (JP)

(72) Inventors: Hisashi Ishida, Tokyo (JP); Risato Ohhira, Tokyo (JP)

(73) Assignee: NEC CORPORATION, Minato-ku, Tokyo (JP)

(21) Appl. No.: 14/365,906

(22) PCT Filed: Nov. 29, 2012
(86) PCT No.: PCT/JP2012/080907

§ 371 Date: Jun. 16, 2014

(30) Foreign Application Priority Data
Dec. 15, 2011 (JP) 2011-274789

(51) Int. Cl. G05F 1/66; G06F 3/0484

(52) U.S. Cl. CPC G05F 1/66; G06F 3/0484
USPC 700/295

(57) ABSTRACT

An electric power system tree display system includes: a specification information storing unit for storing specification information of the mounted parts; a tree information creating unit that reads out the specification information corresponding to design information input from the outside, from the specification information storing unit to prepare system tree information of the mounted parts connected by the electric power paths and determines electric power to be supplied to the mounted parts for each of the electric power paths, based on the read out specification information to prepare characteristic value information on the electric power paths; and a display unit for displaying the characteristic value information superposed on the system tree information.

### TECHNICAL FIELD

The present invention relates to an electric power system tree display system and an electric power system tree display method.

### BACKGROUND ART

Recently, with improvement of the functions of electric appliances, more types of voltages are used in the appliance while the voltages used are increasingly lowered. In order to improve design reliability of such an electric appliance, displaying a tree of the electric power system is an effective way for carrying design and verifying design.

As a technology related to display of the electric power system tree, Patent Document 1 discloses an information processing apparatus in which, based on pre-registered connecting relationships between terminals and devices in the symbolic drawing, terminals in the symbolic drawing are connected to create a hierarchal system tree.

### RELATED ART DOCUMENTS

### Patent Document

Patent Document 1: JP2009-069884A

### SUMMARY OF THE INVENTION

### Problems to be Solved by the Invention

However, in the information processing apparatus disclosed in Patent Document 1, information on the values of the currents flowing through the connecting paths (electric power paths) between terminals, consumption power of devices and the like is not included in the electric power system tree. For this reason, when, for example, it is determined whether or not the value of the current flowing through a electric power path is suitable, it is necessary to display the current value, consumption power, etc., separately, which poses difficulty in efficiently performing design work and design verification work.

It is an object of the present invention to provide an electric power system tree display system, as well as an electric power system tree display method, that enables efficient design work and design verification work.

### Means for Solving the Problems

In order to solve the above problem, an electric power system tree display system for displaying electric power paths between mounted parts mounted on a circuit board in an electronic appliance, includes: a specification information storing unit for storing specification information of the mounted parts; a tree information creating unit that reads out the specification information corresponding to design information input from the outside, from the specification information storing unit to prepare system tree information of the mounted parts connected by the electric power paths and determines the amount of electric power to be supplied to the mounted parts for each of the electric power paths, based on the read out specification information to prepare characteristic value information on the electric power paths; and a display unit for displaying the characteristic value information superposed on the system tree information.

The electric power system tree display method for displaying electric power paths between mounted parts mounted on a circuit board in an electronic appliance, includes: a specification information storing step of storing specification information of the mounted parts; a tree information preparing step of reading out the specification information corresponding to design information input from the outside, from the specification information storing step to prepare system tree information of the mounted parts connected by the electric power paths, and determining the amount of electric power to be supplied to the mounted parts for each of the electric power paths, based on the read specification information to prepare characteristic value information on the electric power paths; and a displaying step of displaying the characteristic value information superposed on the system tree information.

### Effect of the Invention

According to the present invention, since the characteristic value information is displayed together with the system tree information, it is possible to perform design work and design verification work efficiently.

### BRIEF DESCRIPTION OF THE DRAWINGS

FIG. 1 A block diagram showing the first exemplary embodiment of an electric power system tree display system of the present invention.

FIG. 2 A block diagram showing the second exemplary embodiment of an electric power system tree display system of the present invention.

FIG. 3 A diagram showing one example of an electric power system tree displayed by the electric power system tree display system shown in FIG. 2.

FIG. 4 A flow chart for explaining the procedures of displaying the electric power system tree shown in FIG. 3 by electric power system tree display system shown in FIG. 2.

FIG. 5 A diagram showing another example of an electric power system tree displayed by the electric power system tree display system shown in FIG. 2.

FIG. 6 A diagram showing a display example of an electric power system tree of the third exemplary embodiment in an electric power system tree display system according to the present invention.

FIG. 7a A diagram showing a display example of an electric power system tree of the fourth exemplary embodiment in an electric power system tree display system of the present invention.

FIG. 7b A diagram showing a sub-screen showing power supply sequences.

FIG. 8 A diagram showing a display example of an electric power system tree of the fifth exemplary embodiment in an electric power system tree display system of the present invention.

FIG. 9 A diagram showing another display example of an electric power system tree of the fifth exemplary embodiment in an electric power system tree display system of the present invention.

FIG. 10 A diagram showing a display example of an electric power system tree of the sixth exemplary embodiment in an electric power system tree display system of the present invention.

FIG. 11 A diagram showing a display example of an electric power system tree of the seventh exemplary embodiment in an electric power system tree display system of the present invention.

### MODE FOR CARRYING OUT THE INVENTION

### The First Exemplary Embodiment

The first exemplary embodiment of the present invention will be described.

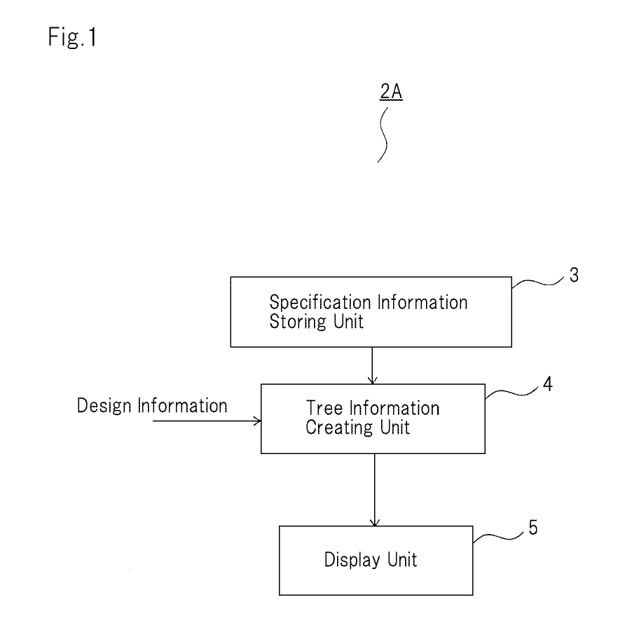

FIG. 1 is a block diagram showing the first exemplary embodiment of an electric power system tree display system of the present invention. Description hereinbelow will be made by taking a case in which power supplies and electronic parts such as devices and others are mounted on a circuit board (printed-circuit board). In this case, the electronic parts mounted on the circuit board are generally referred to as mounted parts.

Electric power system tree display system 2A in the present exemplary embodiment includes, as shown in FIG. 1, specification information storing unit 3, tree information creating unit 4 and display unit 5.

Specification information storing unit 3 is stored with specification information such as device information relating to devices, power supply information relating to power supplies and board information relating to the circuit board and others. Tree information creating unit 4, based on the design information designated by the user, extracts necessary specification information from specification information storing unit 3. Then, tree information creating unit 4, based on the extracted specification information, prepares system tree information including electric power paths and the like forming supply paths of electric power, and characteristic value information such as values of currents flowing through the electric power paths. Display unit 5 displays the system tree information prepared by tree information creating unit 4 and also superposes and displays the characteristic value information prepared by tree information creating unit 4 on the system tree information. Here, “superpose and display” means a displayed state in which the characteristic value information is displayed without hiding the system tree information.

The system tree information and the characteristic value information are displayed on the same screen. Accordingly, the user is allowed to visually recognize the characteristic value information together when viewing the power system tree, so that the user can efficiently perform design work and design verifying work of an electric appliance.

### The Second Exemplary Embodiment

Next, the second exemplary embodiment of the present invention will be described.

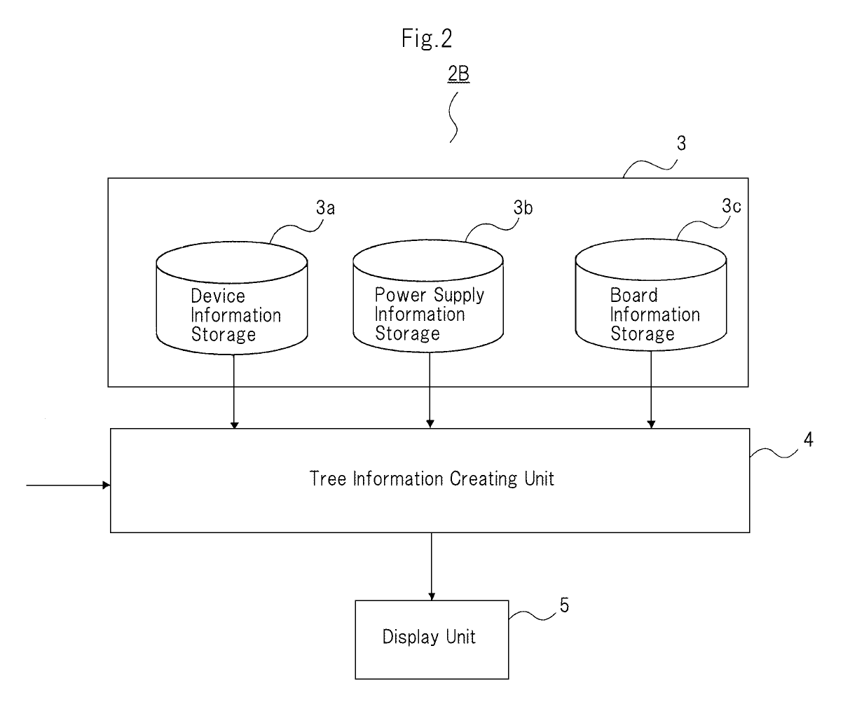

FIG. 2 is a block diagram showing the second exemplary embodiment of an electric power system tree display system of the present invention.

Electric power system tree display system 2B in this exemplary embodiment includes, as shown in FIG. 2, specification information storing unit 3, tree information creating unit 4 and display unit 5.

Specification information storing unit 3 includes device information storage 3a storing device information, power supply information storage 3b storing power supply information and board information storage 3c storing board information. Tree information creating unit 4, based on the design information designated by the user, extracts necessary specification information from specification information storing unit 3. Then, tree information creating unit 4, based on the extracted specification information, prepares system tree information including electric power paths and the like, and characteristic value information such as values of currents flowing through the electric power system tree. Display unit 5 displays the system tree information prepared by tree information creating unit 4 and also superposes and displays the characteristic value information prepared by tree information creating unit 4 on the system tree information.

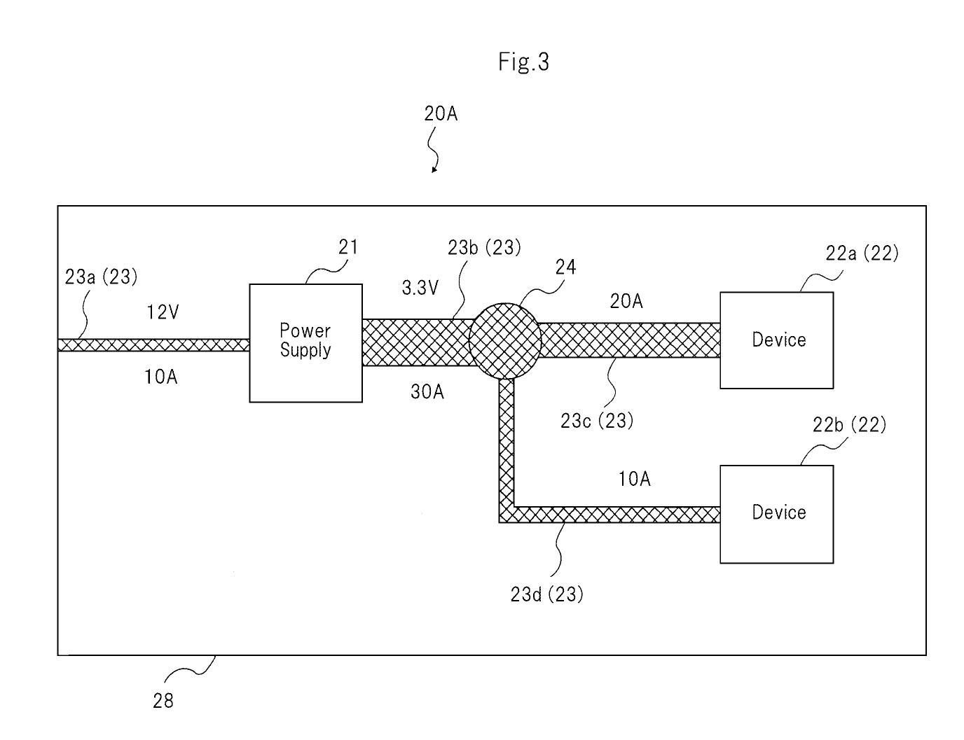

FIG. 3 is a diagram showing one example of an electric power system tree displayed by electric power system tree display system 2B shown in FIG. 2.

Electric power system tree 20A displayed by electric power system tree display system 2B shown in FIG. 2 has power supply 21 and devices 22 (22a, 22b) as power receivers, arranged on circuit board (printed-circuit board) 28, these being connected by electric power paths 23, as shown in FIG. 3. Devices 22 are electronic parts such as IC, memory, functional module and the like.

Electric power paths 23 in electric power system tree 20A include electric power path 23a forming a route from the outside of circuit board 28 to power supply 21, electric power path 23b that connects power supply 21 to branch point 24 and electric power paths 23c and 23d that connect branch point 24 to devices 22a and 22b.

In electric power system tree 20A, system tree information is performed by connecting the mounted parts by electric power paths 23, and characteristic value information on the value of the current that is flowing through electric power paths 23 and on voltage values, and others are superposed and displayed. In this case, each electric power path 23 is shown with the width size corresponding to the value of the current flowing through the electric power path 23. That is, the characteristic value information also includes information relating to the path widths of electric power paths 23.

Since electric power system tree display system 2B in the present exemplary embodiment is not a circuit simulator, the displayed current value does not mean the value of the actual current flowing thorough electric power path 23. That is, the characteristic value information such as current values shows the current values required by devices 22a and 22b as the loads of power supply 21. Since the currents of displayed values will flow through electric power paths 23 when devices 22a and 22b normally operate, these values are written like the values of the currents flowing through electric power paths in the description hereinbelow.

Though, in the above description, the path is displayed with a width size corresponding to the current value, except for this, the color of electric power paths may be made different in accordance with the current value. Further, since the electric power paths are plural, it is possible to use a different color or change the color tone for each electric power path. For example, electric power path 23a showing the path for 12V, and electric power paths 23b, 23c, 23d and branch point 24 showing the paths for 3.3V, may be displayed with different colors. As a result, the user can visually recognize the schematic configuration of electric power paths from the colors only, hence perform design verifying work efficiently in the case of a complicated configuration.

The device information may include physical size (dimensions) of each device 22, the type of voltage (either alternating current or direct current voltage, voltage value and current value), power consumption density and the like. Here, the current value, voltage value, power consumption density and the like are given in, at least, one format of the maximum value, minimum value, mean value, product specified value and the like.

As the specific device information of device 22a, examples include the following: size: 20 mm×20 mm, power consumption: 66 W, power consumption density: 165 mW/mm², the required voltage value: direct current (which will be referred to hereinbelow as DC) 3.3V, the required current value: 20 A. Further, as the voltage range in which device 22a operates normally, DC 3.1V to 3.5V, as the current range, 19 A to 21 A may be included. Similarly, as the specific device information of device 22b, examples include the following: size: 20 mm×20 mm, power consumption: 33 W, power consumption density: 82.5 mW/mm², the required voltage value: DC 3.3V, the required current value: 10 A. Further, as the voltage range in which device 22b operates normally, DC 3.1V to 3.5V, as the current range, 9 A to 11 A may be included.

Examples of the electric power information stored in power supply information storage 3b, include the specifications of the power supply, input DC 12V with a current of 10 A, output DC 3.3V with a current 30 A. This power supply information may include information of electronic parts that the power supply is converters, regulators and the like, and also include information on the input/output values, power conversion efficiencies of these electric parts, and others. The numeric values in this case are a single example. As a specific example, the power supply information of power supply 21 shown in FIG. 3 gives such information that the power source includes a DC-DC converter, the input voltage ranges from 10V to 14V, the input current ranges from 8 A to 15 A, the output voltage ranges from 3.0V to 3.4V, and the output current ranges from 20 A to 40 A. The size of power supply 21 is 30 mm×30 mm, the power consumption density is 23 mW/mm², the power conversion efficiency at the output current of 30 A is 83%.

Examples of the board information stored in board information storage 3c may include the board thickness of circuit board 28, interconnect pattern thickness (the thickness of the conductor such as copper foil or the like that forms electric power paths), the configuration of through-holes used for connection between interconnect patterns. This board information is used to calculate the pattern width (path width) or the number of through-holes in relation to the current flowing through electric power path 23.

As a specific example of the board information, the interconnect pattern is formed of copper foil that is 35 μm thick, the size of through-holes is 0.3 mm φ, the plating thickness is 20 μm, and the board thickness is 1.6 mm.

Next, the procedures of displaying electric power system tree 20A shown in FIG. 3 by electric power system tree display system 2B shown in FIG. 2 will be described.

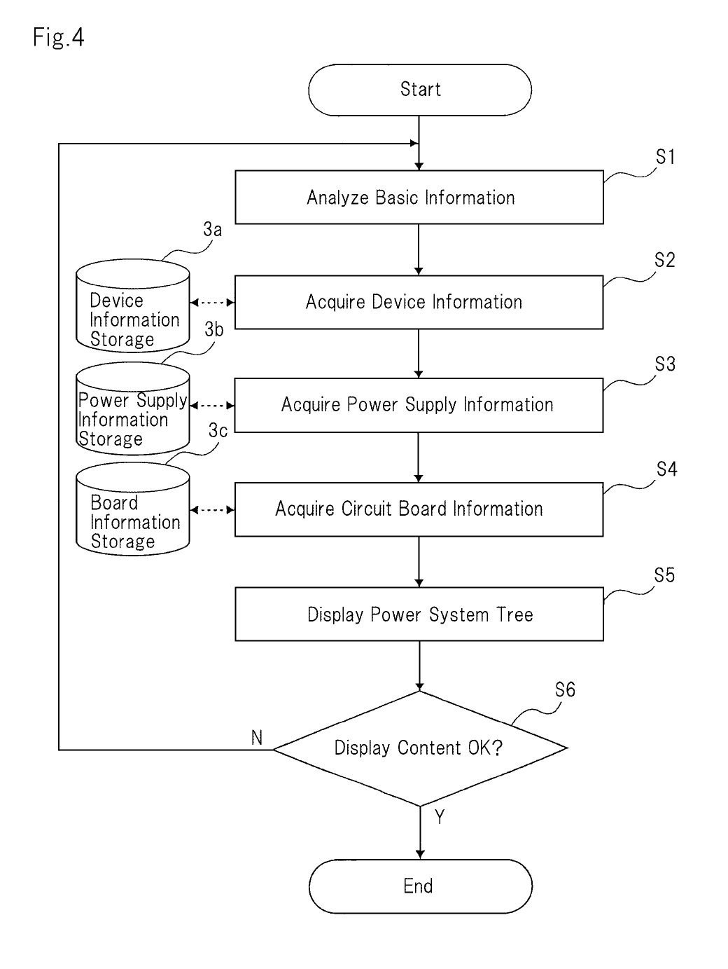

FIG. 4 is a flow chart for explaining the procedures of displaying electric power system tree A shown in FIG. 3 by electric power system tree display system 2B shown in FIG. 2.

Step S1: First, the user analyzes design information, extracts component devices 22 and puts the necessary power supply information (voltage type, power consumption, size, etc.) for each of extracted devices 22 in order.

Step S2: Tree information creating unit 4 acquires device information. At this step, if device information has been filed in the form of a library or the like in device information storage 3a, tree information creating unit 4 acquires the corresponding device information from device information storage 3a. If the corresponding device information has not been stored in device information storage 3a, tree information creating unit 4 requests the user to input the device information in a predetermined data format.

Step S3: Next, tree information creating unit 4 acquires power supply information. Thereby, information on the power to be input to circuit board 28 and power supplies 21 disposed between the input terminals and devices 22 on circuit board 28 is acquired. At this step, if power supply information has been filed in the form of a library or the like in power supply information storage 3b, tree information creating unit 4 acquires the corresponding power supply information from power supply information storage 3b. If the corresponding power supply information has not been stored in power supply information storage 3b, tree information creating unit 4 requests the user to input the power supply information in a predetermined data format.

Step S4: Tree information creating unit 4 further acquires board information. If board information has been filed in the form of a library or the like in board information storage 3c, tree information creating unit 4 acquires the corresponding board information from board information storage 3c. If the corresponding board information has not been stored in board information storage 3c, tree information creating unit 4 requests the user to input the board information in a predetermined data format.

Step S5: Then, tree information creating unit 4 sets up electric power paths that connect devices 22 with power supply 21 to complete the electric power system tree. Further, having set up the electric power paths that connect devices 22 with power supply 21 and having prepared the system tree information, tree information creating unit 4 creates characteristic value information and displays the characteristic value information at predetermined positions. FIG. 3 is a diagram exemplarily showing electric power system tree 20A with the characteristic value information displayed.

That is, tree information creating unit 4, while acquiring device information, power supply information and board information, creates power supply path 23a so as to supply power to power supply 21 from the outside and creates electric power paths that connect power supply 21 to devices 22a and 22b. In this case, since power supply 21 has only one output port, branch point 24 is formed. Thereby, power supply 21 and branch point 24 are connected by electric power path 23b while branch point 24 and device 22a are connected by electric power path 23c and branch point 24 and device 22b are connected by electric power path 23d. At this stage, the system tree information that only gives display data of the connection relationship is prepared.

Next, tree information creating unit 4 computes the path width of each electric power path from the information (specification information) that indicates that power supply 21 receives an input of DC 12V with a current of 10 A and outputs DC 3.3V with a current of 30 A by voltage conversion and from the information (Specification information) that indicates that device 22a needs DC 3.3V with a current of 20 A. That is, tree information creating unit 4 computes the path width of each of the electric power paths connected to power supply 21 and devices 22a and 22b, from the relationship between current value and path width of electric power path in accordance with the previously set rules. Then, the current values, voltage values, path widths are output to display unit 5 as characteristic value information.

Calculation of path widths is implemented using the information included in the board information such as the thickness of the copper foil, through-hole size, the plating thickness of through-holes and the like. For example, suppose that a voltage of 12 V with a current of 10 A is applied to electric power path 23a and the necessary path width is calculated to be 10 mm from the thickness of the copper foil and others included in the board information. It is also assumed that when the electric power output from power supply 21 is DC 3.3V/30 A, the path width of electric power path 23b is calculated to be 20.5 mm. Then, tree information creating unit 4, dividing the computed values into plural levels, sets up a path width for each level. When, for example 10 pixels are allotted to display data for every 10 mm in the computed value, the path width of electric power path 23a is set at 10 pixels, and the path width of electric power path 23b is set at 30 pixels. It goes without saying that the path width may be changed in proportion to the current value.

At Step S6: tree information creating unit 4 waits for indication of whether or not the displayed content is “OK”. The indication of whether or not the displayed content is “OK” is given by the user checking the display screen. When determining that the displayed content is given according to design, the user selects “OK” on the displayed content, and the process is ended. On the other hand, when a change or the like is added to the design, “NO” is selected on the displayed content. By this selection, the process returns to Step S1.

In the above way, by displaying the characteristic value information together with the system tree information in electric power system tree 20A, it is possible for the user to visually grasp the system tree information and characteristic value information that configures the electric power system tree. Accordingly, it is possible to efficiently achieve design work and design verification work and improve their reliability.

Although the above described was made by giving a case of a single power supply, the exemplary embodiment should not be limited to the above configuration.

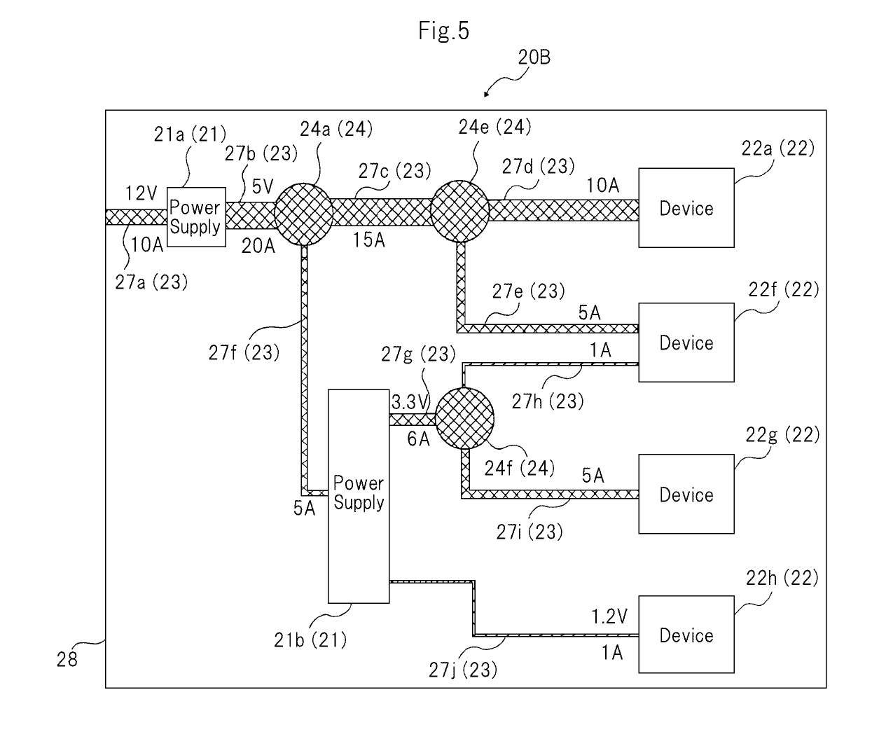

FIG. 5 is a diagram showing another example of an electric power system tree displayed by electric power system tree display system 2B shown in FIG. 2. Electric power system tree 20B in this example includes two power supplies 21a and 21c arranged in two layers.

As shown in FIG. 5, in this example, power source 21a receives power supply from the outside via electric power path 27a and outputs power to electric power path 27b. This electric power path 27b connects power source 21a to branch point 24a. Branch point 24a is connected to branch point 24e via electric power path 27c and is also connected to power supply 21c via electric power path 27f. Branch point 24e is connected to device 22a via electric power path 27d and also connected to device 22f via electric power path 27e. Power supply 21c is connected to branch point 24f via electric power path 27g and is also connected to device 22h via electric power path 27j. Branch point 24f is connected to device 22f via electric power path 27h and is also connected to device 22g via electric power path 27i.

Power supply 21a receives an input of DC 12V/10 A and produces an output of DC 5V/20 A. Power supply 21b receives an input of DC 5V/5 A and produces two outputs of DC 3.3V/6 A and DC 1.2V/1 A. Device 22a needs DC 5V/10 A while device 22f needs DC 5V/5 A and DC 3.3V/1 A. Further, device 22g needs DC 3.3V/5 A, and device 22h needs DC 1.2V/1 A.

Since the characteristic value information described above is superposed and displayed on the system tree information, the user can visually grasp the system tree information and characteristic value information even if the electric power system tree has a complicated configuration. Accordingly, it is possible to efficiently implement design work and design verification work and enhance their reliability.

### The Third Exemplary Embodiment

The third exemplary embodiment of the present invention will be described next.

The electric power system tree displayed in this exemplary embodiment displays not only the path widths of electric power paths, but also displays the dimensional values of path widths, the number of through-holes (T/H) to be used to connect electric power paths and others, by means of electric power system tree display system 2B shown in FIG. 2.

The path widths and the number of through-holes are the information that will be needed at downstream stages for designing circuit patterns and others, for example. Nevertheless, if the information necessary for downstream stages is known at the designing stage, it is possible to implement design reflecting this information, hence improve operativity.

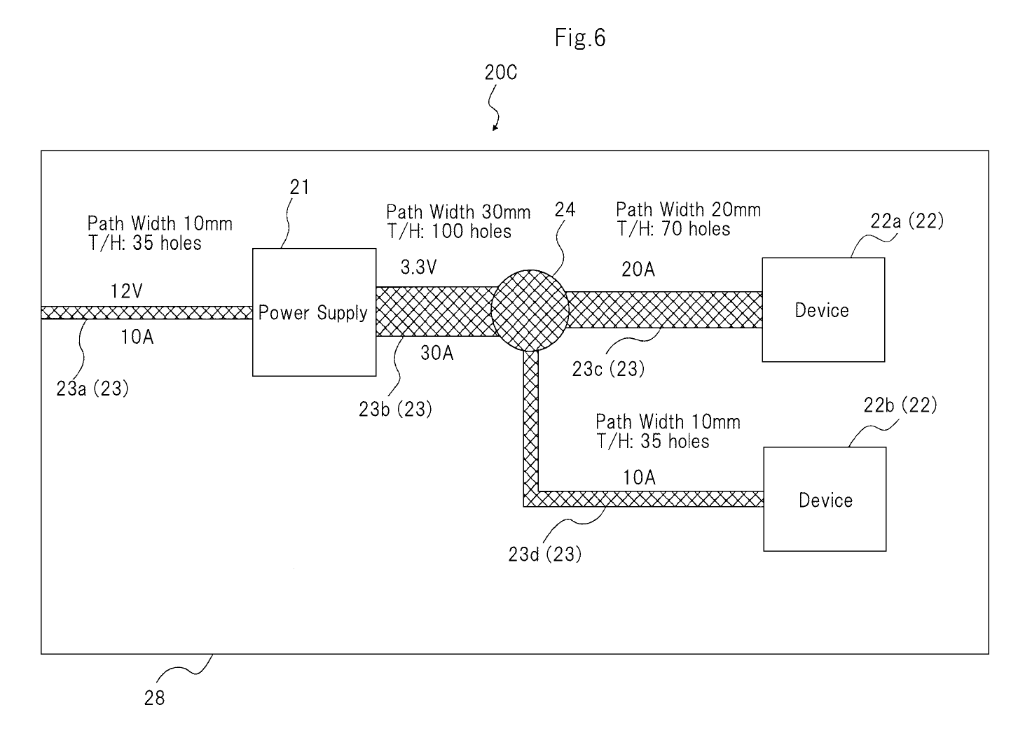

Though the present exemplary embodiment is described by giving an example in which the dimensional values of path widths and the number of through-holes are assumed to be needed at downstream stages, the embodiment should not be limited to this information. In sum, information, which will be needed in downstream stages, and based on which design needs to be changed, may and should be displayed. FIG. 6 is a diagram showing a display example of an electric power system tree of the third exemplary embodiment in an electric power system tree display system of the present invention. Here, the same components as those in the second embodiment are allotted with the same reference numerals, and description is omitted as appropriate.

Displayed as shown in FIG. 6 in electric power system tree display system 20C in this exemplary embodiment, is a case where, for example, as the characteristic value information relating to electric power path 23a, electric power of DC12V with a current of 10 A is supplied to power supply 21 from the outside as information that is needed at downstream stages, the path width of the electric power path is 10 mm and the number of T/H is 35.

Tree information creating unit 4, based on the aforementioned characteristic value information on the current value, voltage value, path width of each electric power path 23 and based on the specification information such as the board thickness, through-hole size and others to transmit the power (current value and voltage value), calculates the necessary path width and the number of through-holes. The method of calculation was described in the second exemplary embodiment. The thus calculated values are included in the characteristic value information, and output on display unit 5.

Accordingly, the user can visually recognize the current values, voltage values and path widths and becomes able to know specific sizes of path widths and the number of through holes. As a result, it is possible to efficiently perform design work and design verification work and inhibit change of design due to reasons at downstream stages.

### The Fourth Exemplary Embodiment

Next, the fourth exemplary embodiment of the present invention will be described.

In the above described exemplary embodiments, when a plurality of mounted parts are used, no information on the operation timings of those parts is displayed. However, since in an actual electronic appliance, multiple number of mounted parts operate in cooperation, consideration of the operation timings is indispensable in designing an electronic appliance to operate stably. Further, there are some occasions in which change of design has to be made due to reasons of the operation timings. In order to know the exact timings for the mounted parts, it is necessary to perform simulation or the like. However, when a plurality of power supplies are used and each power supply outputs at different timing from the others, the assumptions for performing simulation would break down. That is, it is possible to determine whether or not the design is ok without performing simulation.

For this purpose, in the present exemplary embodiment, electric power system tree display system 2B shown in FIG. 2 is adapted to handle the information as the characteristic value information to be used to roughly consider the operation timings before detailed examination of the operation timings.

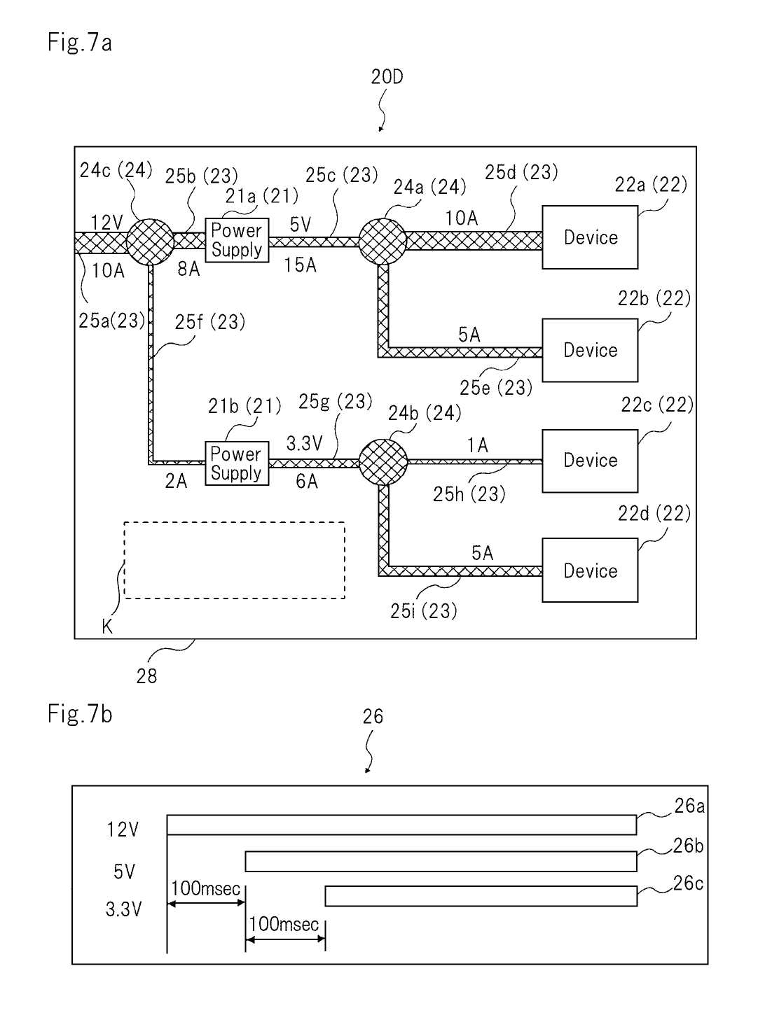

FIG. 7a is a diagram showing a display example of an electric power system tree of the fourth exemplary embodiment in an electric power system tree display system of the present invention. FIG. 7b is a diagram showing a sub-screen that shows power supply sequences. Here, the same components as those in the second embodiment are allotted with the same reference numerals, and description is omitted as appropriate.

The following description will be described by giving an example in which sequences of power supplies 21a and 21b are displayed as sub-screen 26. However, the present embodiment should not be limited to the display of sequences, and other information such as timing charts and the like may be displayed.

As shown in FIG. 7a, electric power of DC 12V with a current of 10 A is supplied from the outside via electric power path 25a and branched at branch point 24c into electric power paths 25b and 25f. Branch point 24c and power supply 21a are connected by electric power path 25b while branch 24c and power supply 21b are connected by electric power path 25f. The current flowing through the electric power path 25b is 8 A and the current flowing though electric power path 25f is 2 A.

In power supply 21a, voltage conversion from DC 12V to DC 5V is performed so that electric power of DC 5V with a current of 15 A is output to electric power path 25c. Electric power path 25c is branched at branch point 24a into electric power paths 25d and 25e. Electric power path 25d is a path that connects branch point 24a and device 22a, and electric power of DC5V/10A is supplied to device 22a. Electric power path 25e is a path that connects branch point 24a and device 22b, and electric power of DC5V/5A is supplied to device 22b.

On the other hand, a current of 2 A flows through electric power path 25f that connects branch point 24c and power supply 21b, and voltage conversion from DC 12V to DC 3.3V is performed at power supply 21b.

Electric power path 25g connects power supply 21b and branch point 24b, and power supply 21b outputs electric power of DC 3.3V with a current of 6 A to electric power path 25g. Electric power path 25g is branched at branch point 24b into electric power paths 25h and 25i. As a result, electric power of DC3.3V/1A is supplied to device 22c via electric power path 25h and electric power of DC3.3V/5A is supplied to device 22d via electric power path 25i.

Tree information creating unit 4 calculates the sequences of power supplies 21a and 21b based on the power supply information and prepares the data that is needed to display sub-screen 26. Herein, the timing at which power is supplied from the outside is assumed to be the reference timing. That is, sequence 26a in FIG. 7b shows a sequence of electric power supplied to circuit board 28 from the outside. Based on this sequence 26a as the reference timing, sequences 26b and 26c of power supplies 21a and 21b are displayed. In FIG. 7b, sequence 26b of power supply 21a shows that electric power of DC5V is output with a delay of 100 msec from the reference timing. Sequence 26c of power supply 21b shows that electric power of DC3.3V is output with a delay of 200 msec from the reference timing.

In this case in FIG. 7b, the delay in sequence 26c is displayed by the time shift from the output timing of sequence 26b. The actually calculated time shift of the output timing is the time shift from the output timing of sequence 26a. However, useful design information is the output timings of power supplies 21a and 21b, that is, the timing at which electric power is supplied to each device (the timing at which each device starts operating). Accordingly, the shift of output timing between sequence 26b and sequence 26c is important. Therefore, in the present exemplary embodiment, the time shift of sequence 26c is displayed on the basis of sequence 26b. With this, the user can grasp the timing shifts of two power supplies 21a and 21b intuitively.

In this way, by displaying not only voltage value, current value and path width, but also output timing of electric power, design can be facilitated and exact design verification can be easily carried out. Here, it is preferable that sub screen 26 is displayed on the same screen of electric power system tree 20D. For example, as shown by the broken line in FIG. 7a, sub-screen 26 may be displayed in the empty space of electric power system tree 20D, namely, area K.

### The Fifth Exemplary Embodiment

Next, the fifth exemplary embodiment of the present invention will be described.

In the first exemplary embodiment, the characteristic value information such as current values and the like is displayed together with the system tree information. In this case, the current value is given by a numeric value such as average, nominal value or the like. However, it is a usual for the current value and the like required for device 22 to be adjusted in accordance with its operation status. To deal with this, in the present exemplary embodiment, the current value is displayed as an operating range specified by the maximum and minimum.

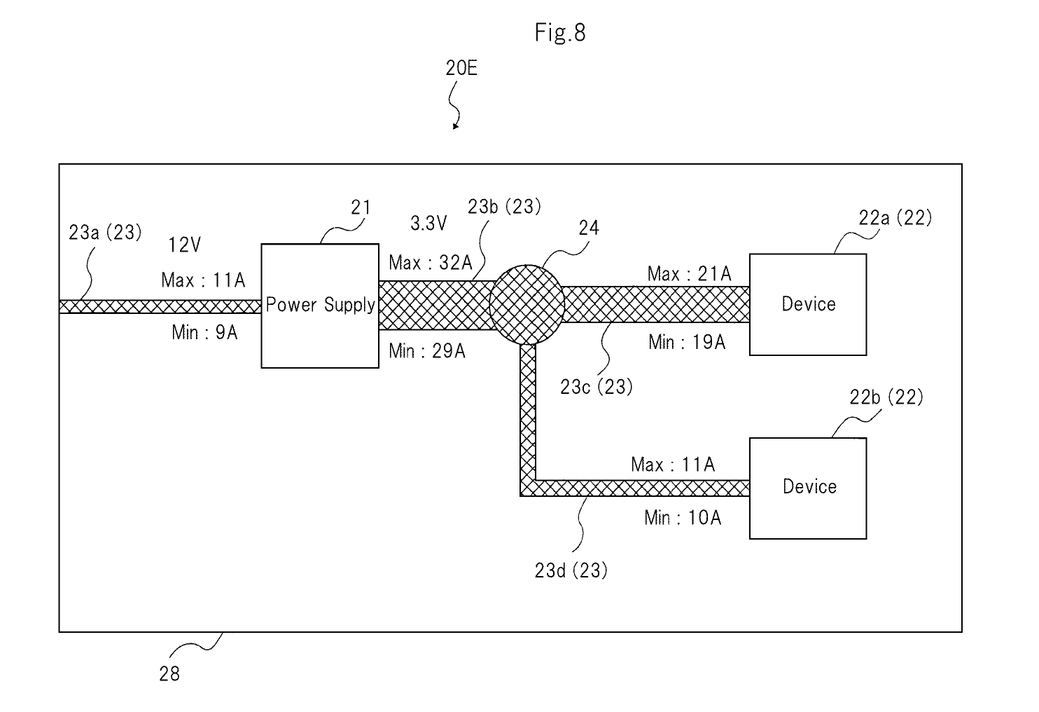

FIG. 8 is a diagram showing a display example of an electric power system tree of the fifth exemplary embodiment in an electric power system tree display system of the present invention. Here, the same components as those in the second embodiment are allotted with the same reference numerals, and description is omitted as appropriate.

As shown in FIG. 8, in this exemplary embodiment, the maximum current value (Max) and the minimum current value (Min) are displayed for each electric power path. This range that is defined between the maximum current value and the minimum current value is the operating range. For example, it is shown that DC12V with a current value of 9 A to 11 A is supplied from the outside to power supply 21 (power supply 21 needs the power).

Though the above description is described by taking a case where the operating range of the current value is displayed, the operating range of the voltage value may be displayed or both of them may also be displayed.

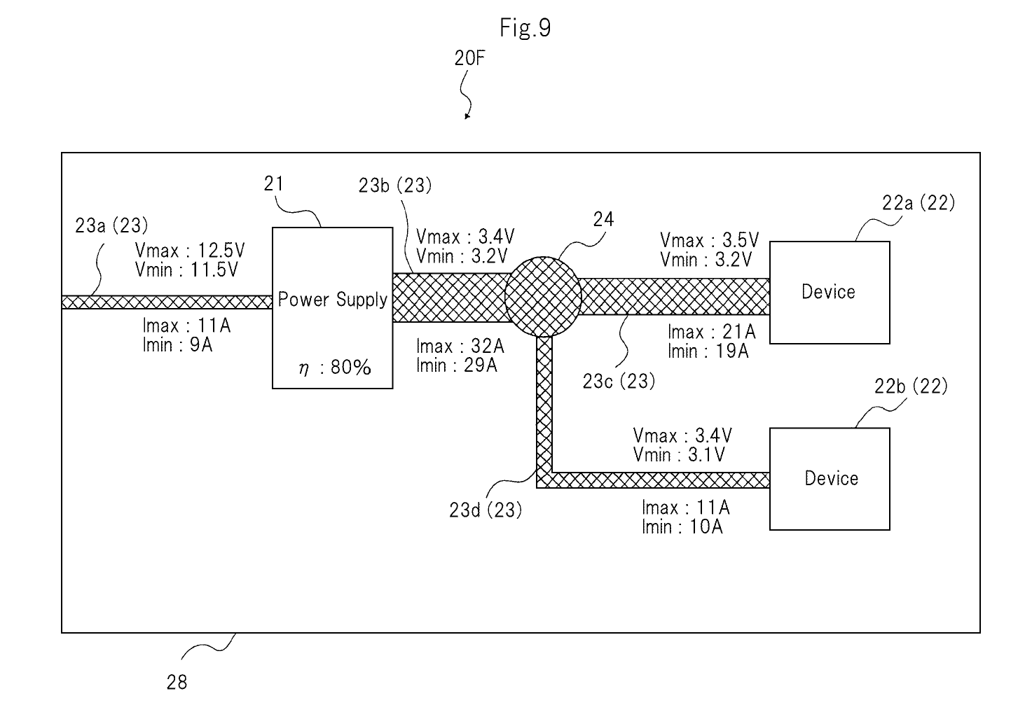

FIG. 9 is a diagram showing another display example of an electric power system tree of the fifth exemplary embodiment in an electric power system tree display system of the present invention.

As shown in FIG. 9, in electric power system tree 20F in this example, the operating range of the current value and the operating range of the voltage value are displayed as the characteristic value information. For a power supply that performs voltage conversion, conversion efficiency η is also displayed. FIG. 9 exemplifies a case where conversion efficiency η=80%. These operating ranges of the current value and voltage value and conversion efficiency η are included in device information or power supply information.

One of the difficulties in design is that design should be done so as to assure a normal operation even when the operating range is narrow. Once trouble occurs, the part with a narrow operating range is liable to have problems. Therefore, at design stage and/or at design verification stage it is necessary to exercise sufficient attention to such a part. Under such circumstances, displaying the operating ranges as the characteristic value information as above makes it possible for the user to carefully check design and design verification. Accordingly, the reliability of design work and design verification work can be improved.

### The Sixth Exemplary Embodiment

Next, the sixth exemplary embodiment of the present invention will be described.

In the above exemplary embodiments, no reference was made to the power consumption of power supplies and devices. The power consumption is a necessary parameter in layout design and heat radiation design of power supplies and devices. This parameter can be handled as information relating to downstream stages in the third exemplary embodiment.

In this exemplary embodiment, the power consumption density is handled as information relating to the downstream stages in electric power system tree display system 2B shown in FIG. 2, and the information can be visually recognized from the displayed state. Specifically, the mounted parts are displayed with colors depending on the power consumption density.

This power consumption density is included in device information and power supply information, and tree information creating unit 4 extracts it from device information storage 3a and power supply information storage 3b.

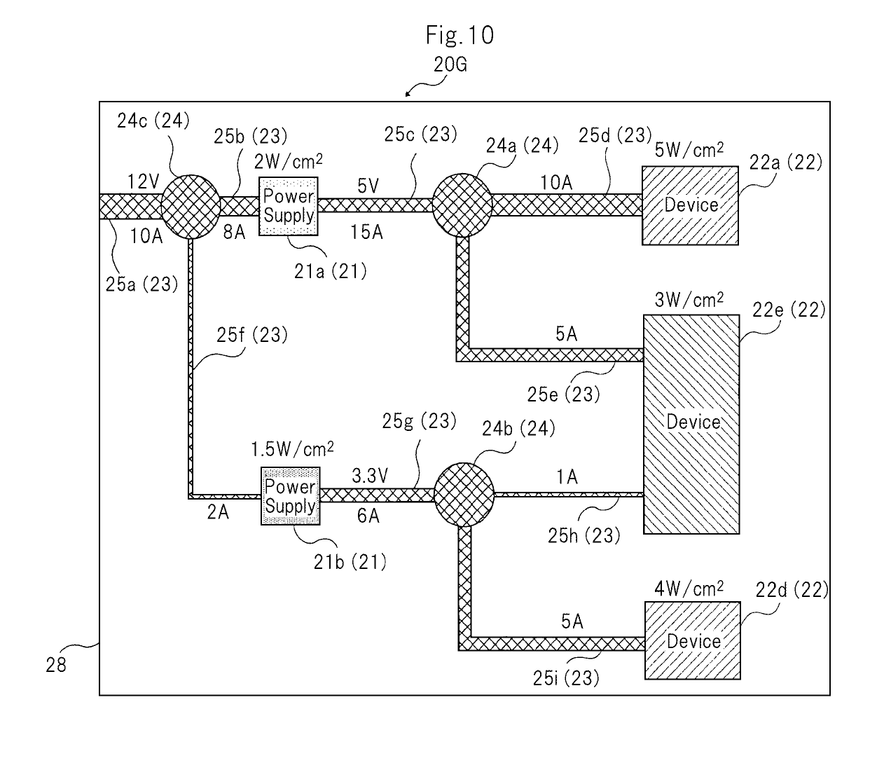

FIG. 10 is a diagram showing a display example of an electric power system tree of the sixth exemplary embodiment in an electric power system tree display system of the present invention. Here, the same components as those in the second embodiment are allotted with the same reference numerals, and description is omitted as appropriate.

For example, when power supply 21a has a power consumption density of 2 W/cm² and power supply 21b has a power consumption density of 1.5 W/cm², device 22a has a power consumption density of 5 W/cm², device 22e has a power consumption density of 3 W/cm² and device 22d has a power consumption density of 4 W/cm², electric power system tree 20G shown in FIG. 10 is displayed.

Further, depending on the power consumption density, the mounted parts are displayed with different display colors. In FIG. 10, the difference in display color is represented by different hatching patterns in the mounted parts. The display color is classified so that cool colors are used for low power consumption density and warm colors are used as the power consumption density increases. It goes without saying that the method of color display is not limited to this. It is possible to display difference in power consumption density by the shade of color. For example, parts with a high consumption power density are displayed with a dark color and parts with a low power consumption density are displayed with a light color. Thus, it becomes possible to visually know difference of power consumption density.

Since the numeric value of power consumption density is also displayed, when designing at downstream process of the board design etc., it is, in particular, possible to easily grasp the heat-generating spots and the like that require attention. Accordingly, it is possible to perform highly reliable circuit design and cooling design in an efficient manner as well as to easily perform design verification.

### The Seventh Exemplary Embodiment

Next, the seventh exemplary embodiment of the present invention will be described.

In the above exemplary embodiments, tree information creating unit 4 prepares system tree information based on the device information, power supply information and board information and creates characteristic value information such as voltage values, power consumption densities and others. The characteristic value information at this time does not mean the electric powers and other values that are actually supplied to electric power paths. For example, in electric power system tree 20A shown in FIG. 3, electric power path 23c is displayed with a current of 20 A, electric power path 23d with a current of 10 A, and electric power path 23b with a current of 30 A. These current values do not mean the value of the current flowing through each path, but show that device 22a needs a current of 20 A and device 22b needs a current of 10 A. It is further shown that loads (devices 22a and 22b) for power supply 21 need a current of 30 A. As a result, there is a case where power supply 21 cannot supply the necessary power if 30 A is needed by the loads of power supply 21. Use of a power supply that lacks supply capacity causes operation failures and the like.

Alternatively, there are cases where the voltage value required by a device does not coincide with the value of the output from a power supply. Also in such a case, the power supply is an unsuitable mounted part.

To deal with this, in the present exemplary embodiment, electric power system tree display system 2B shown in FIG. 2 is adapted so that such a mounted part is displayed as an unsuitable part.

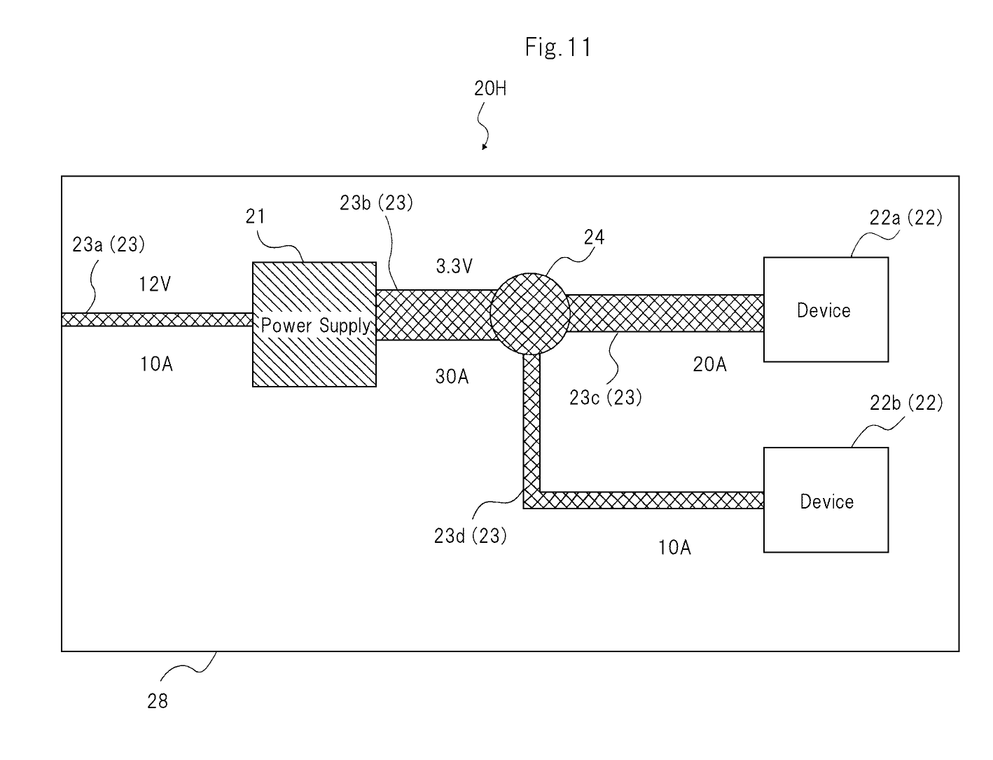

FIG. 11 is a diagram showing a display example of an electric power system tree of the seventh exemplary embodiment in an electric power system tree display system of the present invention. Here, the same components as those in the second embodiment are allotted with the same reference numerals, and description is omitted as appropriate.

As shown in FIG. 11, since, in this exemplary embodiment, power supply 21 does not have a required supply capacity, power supply 21 is represented with red for indicating unsuitable mounted parts. Here in FIG. 11, red representation is shown by hatching that is different from the electric power paths. It goes without saying that indication of an unsuitable mounted part is not limited to red representation. For example, the part may be turned on and off. In a word, any type of representation can be acceptable as long as the unsuitable mounted part can be obviously distinguished from other suitable mounted parts.

Decision of tree information creating unit 4 on whether or not a mounted part is unsuitable or not can be made based on the power specifications (voltage value, current value, etc.) required by the device and the power specifications (output voltage value and output current value) the power supply can afford, from device information storage 3a and power supply information storage 3b.

As described heretofore, since the result of a decision relating to unsuitable mounted parts is handled as the characteristic value information and displayed in the electric power system tree, the user can perform design work and design verification work efficiently.

Part or whole of the above exemplary embodiments is described as the following appendixes, but the invention should not be limited to these.

### Appendix 1

An electric power system tree display system for displaying electric power paths between mounted parts mounted on a circuit board in an electronic appliance, comprising:

a specification information storing unit for storing specification information of the mounted parts;

a tree information creating unit that reads out the specification information corresponding to design information input from the outside, from the specification information storing unit to prepare system tree information of the mounted parts connected by the electric power paths and determines the amount of electric power to be supplied to the mounted parts for each of the electric power paths, based on the read out specification information to prepare characteristic value information on the electric power paths; and

a display unit for displaying the characteristic value information superposed on the system tree information.

### Appendix 2

The electric power system tree display system according to Appendix 1, wherein the specification information storing unit includes:

a device information storage for storing information on devices included in the mounted parts;

a power supply information storage for storing information on power supplies included in the mounted parts; and

a board information storage for storing information on a circuit board included in the mounted parts.

### Appendix 3

The electric power system tree display system according to Appendix 1 or 2, wherein the display unit displays the electric power path with a path width corresponding to the value of current flowing through the electric power path.

### Appendix 4

The electric power system tree display system according to any one of Appendixes 1 to 3, wherein the characteristic value information includes the number of through-holes that penetrate through the circuit board to connect the electric power paths and the dimensional values of the path widths of the electric power paths.

### Appendix 5

The electric power system tree display system according to any one of Appendixes 1 to 4, wherein the characteristic value information includes a sequence showing the operation timing of a power supply.

### Appendix 6

The electric power system tree display system according to any one of Appendixes 1 to 5, wherein the characteristic value information includes the maximum value and minimum value of the current flowing through the electric power path.

### Appendix 7

The electric power system tree display system according to any one of Appendixes 1 to 6, wherein the characteristic value information includes the power consumption density of the mounted part, and

the display unit displays the power consumption density, in at least one display format selected from numeric representation and color representation formats.

### Appendix 8

The electric power system tree display system according to any one of Appendixes 1 to 6, wherein

the tree information creating unit determines whether the mounted part can supply the electric power that is required by another mounted part, and includes the determined information in the characteristic value information, and

the display unit produces color representation in accordance with the determined information.

### Appendix 9

An electric power system tree display method for displaying electric power paths between mounted parts mounted on a circuit board in an electronic appliance, comprising:

a specification information storing step of storing specification information of the mounted parts;

a tree information preparing step of reading out the specification information corresponding to design information input from the outside, from the specification information storing step to prepare system tree information of the mounted parts connected by the electric power paths, and determining the amount of electric power to be supplied to the mounted parts for each of the electric power paths, based on the read specification information to prepare characteristic value information on the electric power paths; and

a displaying step of displaying the characteristic value information superposed on the system tree information.

### Appendix 10

The electric power system tree display method according to Appendix 9, wherein the displaying step displays the electric power path with a path width corresponding to the value of current flowing through the electric power path.

### Appendix 11

The electric power system tree display method according to any one of Appendixes 9 or 10, wherein the characteristic value information includes the number of through-holes that penetrate through the circuit board to connect the electric power paths and the dimensional values of the path widths of the electric power paths.

### Appendix 12

The electric power system tree display method according to any one of Appendixes 9 to 11, wherein the characteristic value information includes a sequence showing the operation timing of the power supply.

### Appendix 13

The electric power system tree display method according to any one of Appendixes 9 to 12, wherein the characteristic value information includes the maximum value and minimum value of the current flowing through the electric power path.

### Appendix 14

The electric power system tree display method according to any one of Appendixes 9 to 13, wherein the characteristic value information includes the power consumption density of the mounted part, and

the displaying step includes a step of displaying the power consumption density, in at least one display format selected from numeric representation and color representation formats.

### Appendix 15

The electric power system tree display method according to any one of Appendixes 9 to 14, wherein

the tree information creating step determines whether the mounted part can supply the electric power that is required by another mounted part, and includes the determined information in the characteristic value information, and

the displaying step includes a step of producing color representation in accordance with the determined information.

Although the present invention has been explained with reference to the exemplary embodiments, the present invention should not be limited to the above exemplary embodiments. Various modifications that can be understood by those skilled in the art may be made to the structures and details of the present invention within the scope of the present invention.

This application claims priority based on Japanese Patent Application No. 2011-274789, filed on Dec. 15, 2011, and should incorporate all the disclosure thereof herein.

1. An electric power system tree display system for displaying electric power paths between mounted parts mounted on a circuit board in an electronic appliance, comprising:
a specification information storing unit for storing specification information of the mounted parts;
a tree information creating unit that reads out the specification information corresponding to design information input from the outside, from the specification information storing unit to prepare system tree information of the mounted parts connected by the electric power paths and determines the amount of electric power to be supplied to the mounted parts for each of the electric power paths, based on the read out specification information to prepare characteristic value information on the electric power paths; and
a display unit for displaying the characteristic value information superposed on the system tree information.

2. The electric power system tree display system according to claim 1, wherein the specification information storing unit includes:
a device information storage for storing information on devices included in the mounted parts;
a power supply information storage for storing information on power supplies included in the mounted parts; and
a board information storage for storing information on a circuit board included in the mounted parts.

3. The electric power system tree display system according to claim 1, wherein the display unit displays the electric power path with a path width corresponding to the value of current flowing through the electric power path.

4. The electric power system tree display system according to claim 1, wherein the characteristic value information includes the number of through-holes that penetrate through the circuit board to connect the electric power paths and the dimensional values of the path widths of the electric power paths.

5. The electric power system tree display system according to claim 1, wherein the characteristic value information includes a sequence showing the operation timing of a power supply.

6. The electric power system tree display system according to claim 1, wherein the characteristic value information includes the maximum value and minimum value of the current flowing through the electric power path.

7. The electric power system tree display system according to claim 1, wherein the characteristic value information includes the power consumption density of the mounted part, and
the display unit displays the power consumption density, in at least one display format selected from numeric representation and color representation formats.

8. The electric power system tree display system according to claim 1, wherein
the tree information creating unit determines whether the mounted part can supply the electric power that is required by another mounted part, and includes the determined information in the characteristic value information, and
the display unit produces color representation in accordance with the determined information.

9. An electric power system tree display method for displaying electric power paths between mounted parts mounted on a circuit board in an electronic appliance, comprising:
a specification information storing step of storing specification information of the mounted parts;
a tree information preparing step of reading out the specification information corresponding to design information input from the outside, from the specification information storing step to prepare system tree information of the mounted parts connected by the electric power paths, and determining the amount of electric power to be supplied to the mounted parts for each of the electric power paths, based on the read specification information to prepare characteristic value information on the electric power paths; and
a displaying step of displaying the characteristic value information superposed on the system tree information.

10. The electric power system tree display method according to claim 9, wherein
the displaying step displays the electric power path with a path width corresponding to the value of current flowing through the electric power path.

11. The electric power system tree display system according to claim 2, wherein the display unit displays the electric power path with a path width corresponding to the value of current flowing through the electric power path.

12. The electric power system tree display system according to claim 2, wherein the characteristic value information includes the number of through-holes that penetrate through the circuit board to connect the electric power paths and the dimensional values of the path widths of the electric power paths.

13. The electric power system tree display system according to claim 3, wherein the characteristic value information includes the number of through-holes that penetrate through the circuit board to connect the electric power paths and the dimensional values of the path widths of the electric power paths.

14. The electric power system tree display system according to claim 2, wherein the characteristic value information includes a sequence showing the operation timing of a power supply.

15. The electric power system tree display system according to claim 3, wherein the characteristic value information includes a sequence showing the operation timing of a power supply.

16. The electric power system tree display system according to claim 4, wherein the characteristic value information includes a sequence showing the operation timing of a power supply.

17. The electric power system tree display system according to claim 2, wherein the characteristic value information includes the maximum value and minimum value of the current flowing through the electric power path.

18. The electric power system tree display system according to claim 3, wherein the characteristic value information includes the maximum value and minimum value of the current flowing through the electric power path.

19. The electric power system tree display system according to claim 4, wherein the characteristic value information includes the maximum value and minimum value of the current flowing through the electric power path.

20. The electric power system tree display system according to claim 5, wherein the characteristic value information includes the maximum value and minimum value of the current flowing through the electric power path.
